(19) United States
(12) Patent Application Publication
(10) Pub. No.: US 2022/0342026 A1
(43) Pub. Date: Oct. 27, 2022

(54) WAVE SOURCE DIRECTION ESTIMATION DEVICE, WAVE SOURCE DIRECTION ESTIMATION METHOD, AND PROGRAM RECORDING MEDIUM

(71) Applicant: NEC Corporation, Minato-ku, Tokyo (JP)

(72) Inventors: Yumi ARAI, Tokyo (JP); Reishi KONDO, Tokyo (JP)

(73) Assignee: NEC Corporation, Minato-ku, Tokyo (JP)

(21) Appl. No.: 17/637,146

(22) PCT Filed: Sep. 2, 2019
(86) PCT No.: PCT/JP2019/034389

§ 371 Date: Feb. 22, 2022

(51) Int. Cl. G01S 3/808; G10L 25/51

(52) U.S. Cl. CPC G01S 3/8083; G10L 25/51

(57) ABSTRACT

A wave source direction estimation device includes a signal extraction unit that sequentially extracts, one at a time, signals of signal segments according to a set time length from at least two input signals based on a wave detected at different detection positions, a function generation unit that generates a function associating at least two signals extracted by the signal extraction unit, a sharpness calculation unit that calculates sharpness of a peak of the function generated by the function generation unit, and a time length calculation unit that calculates the time length based on the sharpness and set the calculated time length.

### TECHNICAL FIELD

The present invention relates to a wave source direction estimation device, a wave source direction estimation method, and a program. Specifically, the present invention relates to a wave source direction estimation device, a wave source direction estimation method, and a program for estimating a wave source direction using signals based on waves detected at different positions.

### BACKGROUND ART

PTL 1 and NPLs 1 and 2 disclose a method of estimating a direction of a sound wave generation source (also referred to as a sound source) from an arrival time difference between sound reception signals of two microphones.

In the method of NPL 1, after a cross spectrum between two sound reception signals is normalized by an amplitude component, a cross-correlation function is calculated by inverse conversion of the normalized cross spectrum, and a sound source direction is estimated by obtaining an arrival time difference at which the cross-correlation function is maximized. The technique of NPL 1 is referred to as a generalized cross correlation with phase transform (GCC-PHAT) method.

In the methods of PTL 1 and NPL 2, the probability density function of the arrival time difference is obtained for each frequency, the arrival time difference is calculated from the probability density function obtained by superposition of the probability density functions, and the sound source direction is estimated. According to the methods of PTL 1 and NPL 2, in a frequency band in which a signal-to-noise ratio (SNR) is high, a probability density function of an arrival time difference forms a sharp peak, so that the arrival time difference can be accurately estimated even when the high SNR band is small.

PTL 2 discloses a sound source direction estimation device that stores a transfer function from a sound source for each direction of the sound source, and calculates the number of hierarchies to be searched and a search interval for each hierarchy based on a desired search range and a desired spatial resolution for searching the direction of the sound source. The device of PTL 2 searches the search range using the transfer function for each search interval, estimates the direction of the sound source based on the search result, updates the search range and the search interval to the calculated number of hierarchies based on the estimated direction of the sound source, and estimates the direction of the sound source.

### CITATION LIST

### Patent Literature

[PTL 1] WO 2018/003158 A
[PTL 2] JP 2014 059180 A

### Non Patent Literature

[NPL 1] C. Knapp, G. Carter, “The generalized correlation method for estimation of time delay,” IEEE Transactions on Acoustics, Speech, and Signal Processing, volume 24, Issue 4, pp. 320-327, August 1976.
[NPL 2] M. Kato, Y. Senda, R. Kondo, “TDOA estimation based on phase-voting cross correlation and circular standard deviation,” 25th European Signal Processing Conference (EUSIPCO), EURASIP, August 2017, p. 1230-1234.

### SUMMARY OF INVENTION

### Technical Problem

In the methods of PTL 1 and NPLs 1 and 2, a time interval for calculating the estimation direction, that is, a time length (hereinafter, referred to as a time length) of data used for obtaining the cross-correlation function or the probability density function at a certain time point is fixed. As the time length increases, the peaks of the cross-correlation function and the probability density function become sharper, and the estimation accuracy increases, while the time resolution decreases. Therefore, when the time length is too long and the direction of the sound source changes greatly over time, there is a problem that the direction of the sound source cannot be accurately tracked. On the contrary, the shorter the time length, the higher the time resolution but the lower the estimation accuracy. Therefore, if the time length is too short, sufficient accuracy cannot be obtained in a case where the noise is large, and there is a problem that the direction of the sound source cannot be accurately estimated.

An object of the present invention is to solve the above-described problems and to provide a wave source direction estimation device and the like capable of achieving both time resolution and estimation accuracy and estimating a direction of a sound source with high accuracy.

### Solution to Problem

A wave source direction estimation device according to an aspect of the present invention includes a signal extraction unit that sequentially extracts, one at a time, signals of signal segments according to a set time length from at least two input signals based on a wave detected at different detection positions, a function generation unit that generates a function associating at least two signals extracted by the signal extraction unit, a sharpness calculation unit that calculates sharpness of a peak of the function generated by the function generation unit, and a time length calculation unit that calculates the time length based on the sharpness and set the calculated time length.

In a wave source direction estimation method according to an aspect of the present invention, the method includes inputting at least two input signals based on a wave detected at different detection positions, sequentially extracting, one at a time, signals of signal segments according to a set time length from the at least two input signals, calculating a cross-correlation function using the at least two signals extracted by a signal extraction unit and the time length, calculating sharpness of a peak of the cross-correlation function, calculating the time length according to the sharpness, and sets the calculated time length to a signal segment to be extracted next.

A program according to an aspect of the present invention causes a computer to execute the steps of inputting at least two input signals based on a wave detected at different detection positions, sequentially extracting, one at a time, signals of signal segments according to a set time length from the at least two input signals, calculating a cross-correlation function using the at least two signals extracted by a signal extraction unit and the time length, calculating sharpness of a peak of the cross-correlation function, calculating the time length according to the sharpness, and sets the calculated time length to a signal segment to be extracted next.

### Advantageous Effects of Invention

According to the present invention, it is possible to provide a wave source direction estimation device and the like capable of achieving both time resolution and estimation accuracy and estimating the direction of the sound source with high accuracy.

### BRIEF DESCRIPTION OF DRAWINGS

FIG. 1 is a block diagram illustrating an example of a configuration of a wave source direction estimation device according to the first example embodiment.

FIG. 2 is a flowchart for explaining an example of an operation of the wave source direction estimation device according to the first example embodiment.

FIG. 3 is a block diagram illustrating an example of a configuration of a wave source direction estimation device according to the second example embodiment.

FIG. 4 is a block diagram illustrating an example of a configuration of an estimated direction information generation unit of the wave source direction estimation device according to the second example embodiment.

FIG. 5 is a flowchart for explaining an example of an operation of the wave source direction estimation device according to the second example embodiment.

FIG. 6 is a flowchart for explaining an example of an operation of an estimation information calculation unit of the wave source direction estimation device according to the second example embodiment.

FIG. 7 is a flowchart for explaining an example of an operation of the estimation information calculation unit of the wave source direction estimation device according to the second example embodiment.

FIG. 8 is a flowchart for explaining an example of an operation of the estimation information calculation unit of the wave source direction estimation device according to the second example embodiment.

FIG. 9 is a block diagram illustrating an example of a configuration of a wave source direction estimation device according to the third example embodiment.

FIG. 10 is a flowchart for explaining an example of an operation of the wave source direction estimation device according to the third example embodiment.

FIG. 11 is a block diagram illustrating an example of a hardware configuration for achieving the wave source estimation device of each example embodiment.

### EXAMPLE EMBODIMENT

Hereinafter, embodiments of the present invention will be described with reference to the drawings. However, the example embodiments described below have technically preferable limitations for carrying out the present invention, but the scope of the invention is not limited to the following. In all the drawings used in the following description of the example embodiment, the same reference numerals are given to the same parts unless there is a particular reason. In the following example embodiments, repeated description of similar configurations and operations may be omitted. The directions of the arrows in the drawings illustrate an example, and do not limit the directions of signals between blocks.

In the following example embodiment, a wave source direction estimation device that estimates a direction of a wave source (also referred to as a sound source) of a sound wave using the sound wave propagating in the air will be described with an example. In the following example, an example of using a microphone as a device that converts a sound wave into an electrical signal will be described.

The wave used when the wave source direction estimation device of the present example embodiment estimates the direction of the wave source is not limited to the sound wave propagating in the air. For example, the wave source direction estimation device of the present example embodiment may estimate the direction of the sound source of the sound wave using the sound wave (underwater sound wave) propagating in the water. When the direction of the sound source is estimated using the underwater sound wave, a hydrophone may be used as a device that converts the underwater sound wave into an electrical signal. For example, the wave source direction estimation device of the present example embodiment can also be applied to estimation of a direction of a generation source of a vibration wave with a solid generated by an earthquake, a landslide, or the like as a medium. When the direction of the generation source of the vibration wave is estimated, a vibration sensor may be used instead of a microphone as a device that converts the vibration wave into an electrical signal. The wave source direction estimation device according to the present example embodiment can be applied to a case where the direction of the wave source is estimated using radio waves in addition to the vibration waves of gas, liquid, and solid. When the direction of the wave source is estimated using radio waves, an antenna may be used as a device that converts radio waves into electrical signals. The wave used by the wave source direction estimation device of the present example embodiment to estimate the wave source direction is not particularly limited as long as the wave source direction can be estimated using a signal based on the wave.

### First Example Embodiment

First, a wave source direction estimation device according to the first example embodiment will be described with reference to the drawings. The wave source direction estimation device according to the present example embodiment generates a cross-correlation function used in a sound source direction estimation method of estimating a sound source direction using an arrival time difference based on the cross-correlation function. An example of the sound source direction estimation method includes a generalized cross-correlation method with phase transform (GCC-PHAT method).

(Configuration)

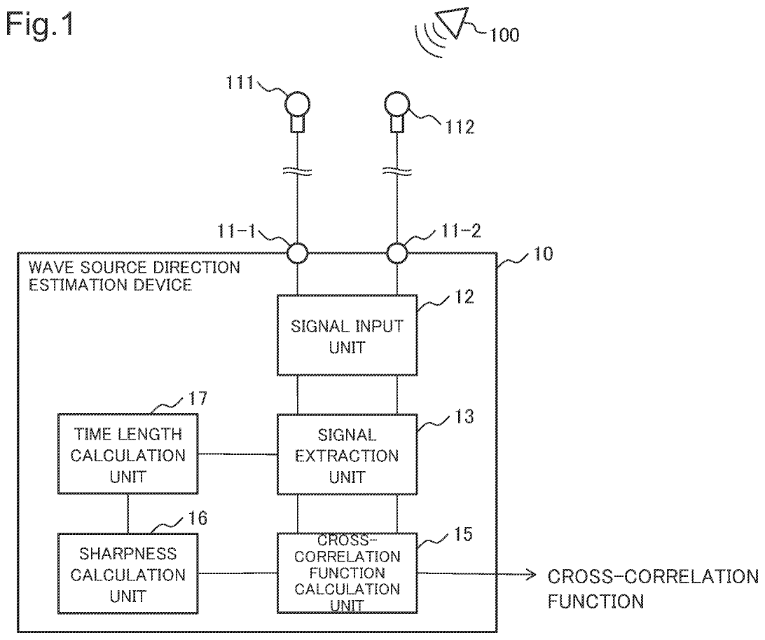

FIG. 1 is a block diagram illustrating an example of a configuration of a wave source direction estimation device 10 according to the present example embodiment. The wave source direction estimation device 10 includes a signal input unit 12, a signal extraction unit 13, a cross-correlation function calculation unit 15, a sharpness calculation unit 16, and a time length calculation unit 17. The wave source direction estimation device 10 includes a first input terminal 11-1 and a second input terminal 11-2.

The first input terminal 11-1 and the second input terminal 11-2 are connected to the signal input unit 12. The first input terminal 11-1 is connected to a microphone 111, and the second input terminal 11-2 is connected to a microphone 112. In the present example embodiment, two microphones (microphones 111, 112) are used as an example, but the number of microphones is not limited to two. For example, when m microphones are used, m input terminals (first input terminal 11-1 to m-th input terminal 11-m) may be provided (m is a natural number).

The microphone 111 and the microphone 112 are disposed at different positions. The positions where the microphone 111 and the microphone 112 are disposed are not particularly limited as long as the direction of the wave source can be estimated. For example, the microphone 111 and the microphone 112 may be disposed adjacent to each other as long as the direction of the wave source can be estimated.

The microphone 111 and the microphone 112 collect sound waves in which sound from a target sound source 100 and various noises generated in the surroundings are mixed. The microphone 111 and the microphone 112 convert collected sound waves into a digital signal (also referred to as sound signal). The microphone 111 and the microphone 112 outputs the converted sound signals to the first input terminal 11-1 and the second input terminal 11-2, respectively.

A sound signal converted from a sound wave collected by each of the microphone 111 and the microphone 112 is input to each of the first input terminal 11-1 and the second input terminal 11-2. The sound signal input to each of the first input terminal 11-1 and the second input terminal 11-2 constitutes a sample value sequence. Hereinafter, a sound signal input to each of the first input terminal 11-1 and the second input terminal 11-2 is referred to as an input signal.

The signal input unit 12 is connected to the first input terminal 11-1 and the second input terminal 11-2. The signal input unit 12 is connected to the signal extraction unit 13. An input signal is input to the signal input unit 12 from each of the first input terminal 11-1 and the second input terminal 11-2. For example, the signal input unit 12 performs a signal process such as filtering and noise removal on the input signal. Hereinafter, the input signal with the sample number t input to the m-th input terminal 11-m is referred to as an m-th input signal xₘ(t) (t is a natural number). For example, the input signal input from the first input terminal 11-1 is referred to as a first input signal x₁(t), and the input signal input from the second input terminal 11-2 is referred to as a second input signal x₂(t). The signal input unit 12 outputs the first input signal x₁(t) and the second input signal x₂(t) input from the first input terminal 11-1 and the second input terminal 11-2, respectively, to the signal extraction unit 13. When signal process is unnecessary, the signal input unit 12 may be omitted, and an input signal may be input to the signal extraction unit 13 from each of the first input terminal 11-1 and the second input terminal 11-2.

The signal extraction unit 13 is connected to the signal input unit 12, the cross-correlation function calculation unit 15, and the time length calculation unit 17. The first input signal x₁(t) and the second input signal x₂(t) are input from the signal input unit 12 to the signal extraction unit 13. A time length T is input from the time length calculation unit 17 to the signal extraction unit 13. The signal extraction unit 13 extracts a signal having a time length input from the time length calculation unit 17 from each of the first input signal x₁(t) and the second input signal x₂(t) input from the signal input unit 12. The signal extraction unit 13 outputs a signal having a time length extracted from each of the first input signal x₁(t) and the second input signal x₂(t) to the cross-correlation function calculation unit 15. When the signal input unit 12 is omitted, an input signal may be input to the signal extraction unit 13 from each of the first input terminal 11-1 and the second input terminal 11-2.

For example, the signal extraction unit 13 determines sample numbers of the beginning and the end in order to extract a waveform of the time length set by the time length calculation unit 17 while shifting the waveform from each of the first input signal x₁(t) and the second input signal x₂(t). The signal segment extracted at this time is referred to as a frame, and the length of the waveform of the extracted frame is referred to as a time length.

The time length Tₙ input from the time length calculation unit 17 is set as the time length of the n-th frame (n is an integer equal to or more than 0, and Tₙ is an integer equal to or more than 1). The extract position may be determined such that the frames do not overlap each other, or may be determined such that part of the frames overlap each other. When the frames partially overlap, for example, a position obtained by subtracting 50% of the time length Tₙ from the end position (sample number) of the n-th frame can be determined as the beginning sample number of the (n+1)th frame. In the case that the frames partially overlap each other, for example, it can be determined by the number of samples in which the consecutive frames overlap each other instead of the ratio in which the consecutive frames overlap each other.

The cross-correlation function calculation unit 15 (also referred to as a function generation unit) is connected to the signal extraction unit 13 and the sharpness calculation unit 16. Two signals extracted at the time length Tₙ are input from the signal extraction unit 13 to the cross-correlation function calculation unit 15. The cross-correlation function calculation unit 15 calculates a cross-correlation function using the two signals having the time length Tₙ input from the signal extraction unit 13. The cross-correlation function calculation unit 15 outputs the calculated cross-correlation function to the sharpness calculation unit 16 of the wave source direction estimation device 10 and the outside. The cross-correlation function output by the cross-correlation function calculation unit 15 to the outside is used for estimation of the wave source direction.

For example, the cross-correlation function calculation unit 15 calculates a cross-correlation function Cₙ(τ) in the n-th frame extracted from the first input signal x₁(t) and the second input signal x₂(t) by using the following Expression 1-1 (tₙ≤t≤tₙ+Tₙ−1).

$${C}_{n} ( τ ) = {\sum }_{t = {t}_{n}}^{{t}_{n} + {T}_{n} - 1} {x}_{1} ( t ) {x}_{2} ( t + τ ) \qquad ( 1 - 1 )$$

In Expression 1-1 described above, tₙ represents the beginning sample number of the n-th frame, and τ represents the lag time.

For example, the cross-correlation function calculation unit 15 calculates a cross-correlation function Cₙ(τ) in the n-th frame extracted using the following Expression 1-2 (tₙ≤t≤tₙ+Tₙ−1). In the following Expression 1-2, first, the cross-correlation function calculation unit 15 converts the first input signal x₁(t) and the second input signal x₂(t) into frequency spectra by Fourier transform or the like, and then calculates the cross spectrum S₁₂. Then, the cross-correlation function calculation unit 15 calculates the cross-correlation function Cₙ(τ) by normalizing the calculated cross spectrum S₁₂ with the absolute value of the cross spectrum S₁₂ and then performing an inverse conversion on the normalized cross spectrum.

$${C}_{n} ( τ ) = \frac{1}{K} {\sum }_{k = 0}^{K - 1} \frac{{S}_{12} ( k )}{\vert {S}_{12} ( k ) \vert} {e}^{j \frac{2 π τ k}{K}} \qquad ( 1 - 2 )$$

In Expression 1-2 described above, k represents a frequency bin number, and K represents the total number of frequency bins.

The cross-correlation function output from the cross-correlation function calculation unit 15 is used, for example, for estimation of a sound source direction by a generalized cross correlation with phase transform (GCC-PHAT) method disclosed in NPL 1 or the like. By using the GCC-PHAT method, the sound source direction can be estimated by obtaining the arrival time difference at which the cross-correlation function is maximized.
(NPL 1: C. Knapp, G. Carter, “The generalized correlation method for estimation of time delay,” IEEE Transactions on Acoustics, Speech, and Signal Processing, volume 24, Issue 4, pp. 320-327, August 1976.)

The sharpness calculation unit 16 is connected to the cross-correlation function calculation unit 15 and the time length calculation unit 17. A cross-correlation function is input from the cross-correlation function calculation unit 15 to the sharpness calculation unit 16. The sharpness calculation unit 16 calculates sharpness s of the peak of the cross-correlation function input from the cross-correlation function calculation unit 15. The sharpness calculation unit 16 outputs the calculated sharpness s to the time length calculation unit 17.

For example, the sharpness calculation unit 16 calculates a peak-signal to noise ratio (PSNR) of the peak of the cross-correlation function as the sharpness s. The PSNR is generally used as an index representing sharpness of a cross-correlation function. The PSNR is also referred to as a peak-to-sidelobe ratio (PSR).

For example, the sharpness calculation unit 16 calculates the PSNR as the sharpness s by using the following Expression 1-3.

$$s = PSNR = \frac{{p}^{2}}{{σ}^{2}} \qquad ( 1 - 3 )$$

In Expression 1-3, p is a peak value of the cross-correlation function, and σ² is a variance of the cross-correlation function.

For example, the sharpness calculation unit 16 extracts a maximum value of the cross-correlation function as the peak value p of the cross-correlation function. For example, the sharpness calculation unit 16 may extract the maximum value by a target sound source (referred to as a target sound) from a plurality of maximum values. In a case of extracting the maximum value by the target sound, the sharpness calculation unit 16 extracts, for example, from a peak position of the target sound at a past time (a lag time τ at which the cross-correlation function peaks), the maximum value in a certain time range around a peak position.

For example, the sharpness calculation unit 16 extracts the variance of the cross-correlation function for the total lag time τ as the variance σ² of the cross-correlation function. For example, the sharpness calculation unit 16 extracts a variance σ² of the cross-correlation function in a segment excluding the vicinity of the lag time τ at the peak value p of the cross-correlation function.

The time length calculation unit 17 is connected to the signal extraction unit 13 and the sharpness calculation unit 16. The sharpness s is input from the sharpness calculation unit 16 to the time length calculation unit 17. The time length calculation unit 17 calculates a time length Tₙ₊₁ in the next frame using the sharpness s input from the sharpness calculation unit 16. The time length calculation unit 17 outputs the calculated time length Tₙ₊₁ in the next frame to the signal extraction unit 13.

For example, when the sharpness s falls below a preset threshold value, the time length calculation unit 17 increases the time length Tₙ₊₁. On the other hand, when the sharpness exceeds a preset threshold value, the time length calculation unit 17 decreases the time length Tₙ₊₁.

For example, it is assumed that the sharpness of the n-th frame is sₙ, the preset sharpness threshold value is sₜₕ, and the time length of the (n+1)th frame is Tₙ₊₁ (n is an integer equal to or more than 0). At this time, for example, the time length calculation unit 17 calculates the time length Tₙ₊₁ of the (n+1)th frame by using the following Expression 1-4.

Tₙ₊₁=Tₙ×a₁+b₁(sₙ<sₜₕ)

Tₙ₊₁=Tₙ/a₂-b₂(sₙ≥sₜₕ) (1-4)

In Expression 1-4, a₁ and a₂ are constants equal to or more than 1, and b₁ and b₂ are constants equal to or more than 0. An initial value T₀ is set to the time length of the 0-th frame. Further, a₁, a₂, b₁, and b₂ are set such that the time length Tₙ₊₁ of the (n+1)th frame is an integer.

In Expression 1-4 described above, the time length Tₙ₊₁ of the (n+1)th frame is set to be an integer of one or more. Therefore, for example, when the time length Tₙ₊₁ of the (n+1)th frame calculated using the above Expression 1-4 is less than one, the time length Tₙ₊₁ of the (n+1)th frame is set to one. For example, the minimum value and the maximum value of the time length T may be set in advance, and the minimum value may be set to the time length Tₙ₊₁ of the (n+1)th frame when the time length Tₙ₊₁ of the (n+1)th frame calculated using the above Expression 1-4 is less than the minimum value, and the maximum value may be set to the time length Tₙ₊₁ of the (n+1)th frame when the time length Tₙ₊₁ exceeds the maximum value.

For example, the threshold value sₜₕ of the sharpness may be set by calculating a cross-correlation function when the signal-to-noise ratio (SN ratio) or the time length is changed and the sharpness of the cross-correlation function by simulation in advance. For example, in the process of increasing the SN ratio and the time length, the value of the sharpness when the peak of the cross-correlation function starts to appear can be set as the threshold value sₜₕ. For example, in the process of increasing the SN ratio and the time length, a value when the sharpness starts to increase can be set as the threshold value sₜₕ.

An example of the configuration of the wave source direction estimation device 10 of the present example embodiment is described above. The configuration of the wave source direction estimation device 10 in FIG. 1 is an example, and the configuration of the wave source direction estimation device 10 of the present example embodiment is not limited to the example.

(Operation)

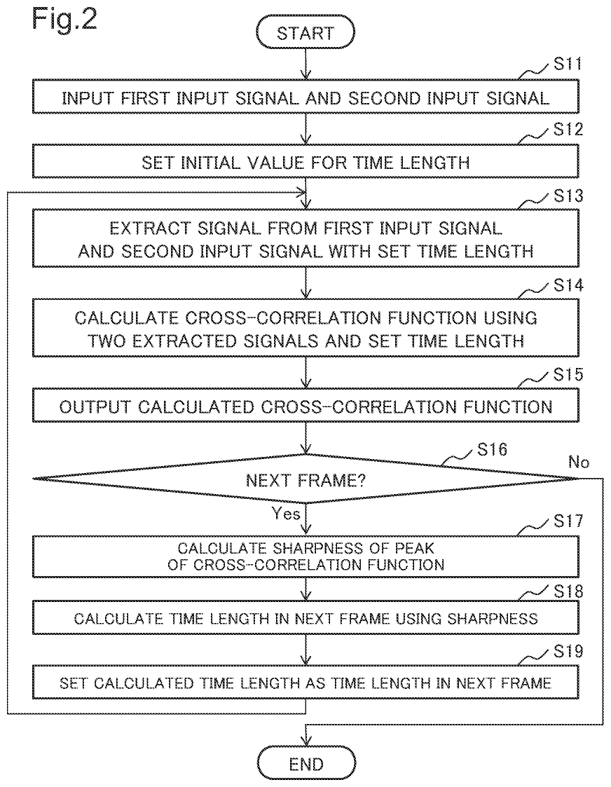

Next, an example of the operation of the wave source direction estimation device 10 of the present example embodiment will be described with reference to the drawings. FIG. 2 is a flowchart for explaining the operation of the wave source direction estimation device 10.

In FIG. 2, first, a first input signal and a second input signal are input to the signal input unit 12 of the wave source direction estimation device 10 (step S11).

Next, the signal extraction unit 13 of the wave source direction estimation device 10 sets an initial value for the time length (step S12).

Next, the signal extraction unit 13 of the wave source direction estimation device 10 extracts a signal from each of the first input signal and the second input signal at a set time length (step S13).

Next, the cross-correlation function calculation unit 15 of the wave source direction estimation device 10 calculates a cross-correlation function using two signals extracted from the first input signal and the second input signal and the set time length (step S14).

Next, the cross-correlation function calculation unit 15 of the wave source direction estimation device 10 outputs the calculated cross-correlation function (step S15). The cross-correlation function calculation unit 15 of the wave source direction estimation device 10 may output the cross-correlation function each time the cross-correlation function for each frame is calculated, or may collectively output the cross-correlation functions of several frames.

Here, when there is the next frame (Yes in step S16), the sharpness calculation unit 16 of the wave source direction estimation device 10 calculates the sharpness of the cross-correlation function calculated in step S14 (step S17). On the other hand, when there is no next frame (No in step S16), the process according to the flowchart of FIG. 2 ends.

Next, the time length calculation unit 17 of the wave source direction estimation device 10 calculates the time length of the next frame using the sharpness calculated in step S17 (step S18).

Next, the time length calculation unit 17 of the wave source direction estimation device 10 sets the calculated time length as the time length in the next frame (step S19). After step S19, the process returns to step S13.

An example of the operation of the wave source direction estimation device 10 of the present example embodiment is described above. The operation of the wave source direction estimation device 10 in FIG. 2 is an example, and the operation of the wave source direction estimation device 10 of the present example embodiment is not limited to the procedure as it is.

As described above, the wave source direction estimation device of the present example embodiment includes the signal input unit, the signal extraction unit, the cross-correlation function calculation unit, the sharpness calculation unit, and the time length calculation unit. At least two input signals based on a wave detected at different positions are input to the signal input unit. The signal extraction unit sequentially extracts, one at a time, signals of signal segments according to a set time length from at least two input signals. A cross-correlation function calculation unit (also referred to as a function generation unit) converts at least two signals extracted by the signal extraction unit into a frequency spectrum, and calculates a cross spectrum of at least two signals after conversion into the frequency spectrum. The cross-correlation function calculation unit calculates a cross-correlation function by normalizing the calculated cross spectrum with an absolute value of the cross spectrum and then performing an inverse conversion on the normalized cross spectrum. The sharpness calculation unit calculates the sharpness of a cross-correlation function peak. The time length calculation unit calculates a time length based on the sharpness and makes the calculated time length the set time length.

In an embodiment of the present example embodiment, the sharpness calculation unit calculates the kurtosis of a peak of a cross-correlation function as the sharpness.

In an embodiment of the present example embodiment, the time length calculation unit of the wave source direction estimation device does not update the time length when the sharpness falls within a range between a minimum threshold value and a maximum threshold value set in advance. On the other hand, the time length calculation unit of the wave source direction estimation device increases the time length when the sharpness is smaller than the minimum threshold value, and decreases the time length when the sharpness is larger than the maximum threshold value.

In the present example embodiment, the time length in the next frame is determined based on the sharpness of the cross-correlation function in the previous frame. Specifically, in the present example embodiment, when the sharpness of the cross-correlation function in the previous frame is small, the time length in the next frame is increased, and when the sharpness of the cross-correlation function in the previous frame is large, the time length in the next frame is decreased. As a result, according to the present example embodiment, since control is performed so that the sharpness is sufficiently large and the time length is as small as possible, the direction of the sound source can be estimated with high accuracy. In other words, according to the present example embodiment, it is possible to achieve both time resolution and estimation accuracy and to estimate the direction of the sound source with high accuracy.

### Second Example Embodiment

Next, a wave source direction estimation device according to the second example embodiment will be described with reference to the drawings. The wave source direction estimation device according to the present example embodiment calculates a probability density function of an arrival time difference for each frequency to generate estimated direction information used for a sound source direction estimation method of calculating an arrival time difference from a probability density function obtained by superimposing the probability density functions of the arrival time differences calculated for each frequency.

(Configuration)

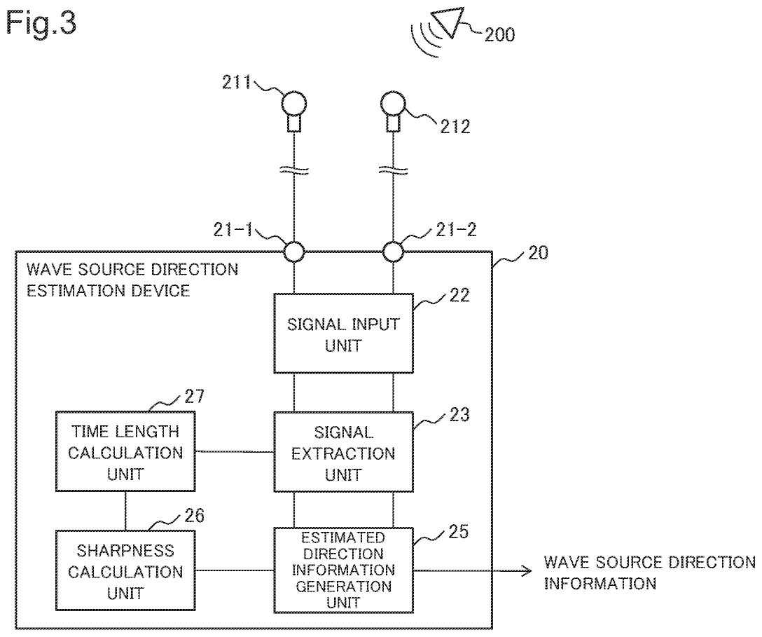

FIG. 3 is a block diagram illustrating an example of a configuration of a wave source direction estimation device 20 according to the present example embodiment. The wave source direction estimation device 20 includes a signal input unit 22, a signal extraction unit 23, an estimated direction information generation unit 25, a sharpness calculation unit 26, and a time length calculation unit 27. The wave source direction estimation device 20 includes a first input terminal 21-1 and a second input terminal 21-2.

The first input terminal 21-1 and the second input terminal 21-2 are connected to the signal input unit 22. The first input terminal 21-1 is connected to a microphone 211, and the second input terminal 21-2 is connected to a microphone 212. In the present example embodiment, two microphones (microphones 211, 212) are used as an example, but the number of microphones is not limited to two. For example, when m microphones are used, m input terminals (first input terminal 21-1 to m-th input terminal 21-m) may be provided (m is a natural number).

The microphone 211 and the microphone 212 are disposed at different positions. The microphone 211 and the microphone 212 collect sound waves in which sound from the target sound source 200 and various noises generated in the surroundings are mixed. The microphone 211 and the microphone 212 convert collected sound waves into digital signals (also referred to as sound signals). The microphone 211 and the microphone 212 outputs the converted sound signals to the first input terminal 21-1 and the second input terminal 21-2, respectively.

A sound signal converted from a sound wave collected by each of the microphone 211 and the microphone 212 is input to each of the first input terminal 21-1 and the second input terminal 21-2. The sound signal input to each of the first input terminal 21-1 and the second input terminal 21-2 constitutes a sample value sequence. Hereinafter, a sound signal input to each of the first input terminal 21-1 and the second input terminal 21-2 is referred to as an input signal.

The signal input unit 22 is connected to the first input terminal 21-1 and the second input terminal 21-2. The signal input unit 22 is connected to the signal extraction unit 23. An input signal is input to the signal input unit 22 from each of the first input terminal 21-1 and the second input terminal 21-2. Hereinafter, the input signal of the sample number t input to the m-th input terminal 21-m is referred to as an m-th input signal xₘ(t) (t is a natural number). For example, the input signal input from the first input terminal 21-1 is referred to as a first input signal x₁(t), and the input signal input from the second input terminal 21-2 is referred to as a second input signal x₂(t). The signal input unit 22 outputs the first input signal x₁(t) and the second input signal x₂(t) input from the first input terminal 21-1 and the second input terminal 21-2, respectively, to the signal extraction unit 23. The signal input unit 22 may be omitted, and an input signal may be input to the signal extraction unit 23 from each of the first input terminal 21-1 and the second input terminal 21-2.

The signal input unit 22 acquires position information (hereinafter, also referred to as microphone position information) of the microphone 211 and the microphone 212, which are supply sources of the first input signal x₁(t) and the second input signal x₂(t), respectively. For example, the first input signal x₁(t) and the second input signal x₂(t) may include microphone position information of respective supply sources, and microphone position information may be extracted from each of the first input signal x₁(t) and the second input signal x₂(t). The signal input unit 22 outputs the acquired microphone position information to the estimated direction information generation unit 25. The signal input unit 22 may output the microphone position information to the estimated direction information generation unit 25 via a path (not illustrated) or may output the microphone position information to the estimated direction information generation unit 25 via the signal extraction unit 23. When the microphone position information of the microphone 211 and the microphone 212 is known, the microphone position information may be stored in a storage unit accessible by the estimated direction information generation unit 25.

The signal extraction unit 23 is connected to the signal input unit 22, the estimated direction information generation unit 25, and the time length calculation unit 27. The first input signal x₁(t) and the second input signal x₂(t) are input from the signal input unit 22 to the signal extraction unit 23. Time length Tⁱ and sharpness s are input from the time length calculation unit 27 to the signal extraction unit 23.

The signal extraction unit 23 extracts a signal having the time length Tⁱ input from the time length calculation unit 27 from each of the first input signal x₁(t) and the second input signal x₂(t) input from the signal input unit 22. The signal extraction unit 23 outputs a signal having the time length Tⁱ extracted from each of the first input signal x₁(t) and the second input signal x₂(t) to the estimated direction information generation unit 25. When the signal input unit 22 is omitted, an input signal may be input to the signal extraction unit 23 from each of the first input terminal 21-1 and the second input terminal 21-2.

For example, the signal extraction unit 23 determines sample numbers of the beginning and the end in order to extract a signal having the time length Tⁱ set by the time length calculation unit 27 while shifting the signal from each of the first input signal x₁(t) and the second input signal x₂(t). The signal segment extracted at this time is referred to as an averaging frame. Here, a number of the current averaging frame (hereinafter, referred to as a current averaging frame) is denoted as n, and the number of times the time length is updated in the time length calculation unit 27 is denoted as i. The time length Tⁱ indicates that the time length of the current averaging frame n has been updated i times.

The signal extraction unit 23 calculates a signal extraction segment of the current averaging frame n using the sharpness s input from the time length calculation unit 27. The signal extraction unit 23 updates the calculated signal extraction segment.

When the sharpness s input from the time length calculation unit 27 is not included in the preset range (sₘᵢₙ to sₘₐₓ), that is, when s≤sₘᵢₙ or s≥sₘₐₓ is satisfied, the signal extraction unit 23 calculates the signal extraction segment of the current averaging frame n using the following Expression 2-1.

tₙ≤t<tₙ+Tⁱ−1 (2-1)

For example, tₙ is calculated using the end sample number (tₙ₋₁+T^{j}−1) of the signal extraction segment in the previous averaging frame n−1, where j is an integer satisfying 0≤j≤i.

For example, the signal extraction unit 23 calculates tₙ using the following Expressions 2-2 and 2-3.

tₙ=(tₙ₋₁+T^{j}−1)+1 (2-2)

tₙ=(tₙ₋₁+T^{j}−1)−Tⁱ×p (2-3)

In Expression 2-3, p represents a ratio at which adjacent averaging frames overlap each other (0≤p≤1).

On the other hand, when the sharpness s input from the time length calculation unit 27 is included in the preset range (sₘᵢₙ to sₘₐₓ), that is, when sₘᵢₙ<s<sₘₐₓ is satisfied, the signal extraction unit 23 ends the update of the current averaging frame n and calculates the signal extraction segment of the next averaging frame n+1. For example, the signal extraction unit 23 calculates a signal extraction segment of the next averaging frame n+1 using the following Expression 2-4.

tₙ₊₁≤t<tₙ₊₁+Tⁱ−1 (2-4)

In Expression 2-4 described above, tₙ₊₁ is calculated using the end sample number of the signal extraction segment of the current averaging frame n, similarly to Expression 2-2 and Expression 2-3 described above. Then, the signal extraction unit 23 continues the process with the next averaging frame n+1 as the current averaging frame n.

The estimated direction information generation unit 25 is connected to the signal extraction unit 23 and the sharpness calculation unit 26. Two signals extracted with the updated signal extraction segment are input from the signal extraction unit 13 to the estimated direction information generation unit 25. The estimated direction information generation unit 25 calculates a probability density function using the two signals input from the signal extraction unit 23. The estimated direction information generation unit 25 outputs the calculated probability density function to the sharpness calculation unit 26.

When the calculation of the probability density function for all the averaging frames is completed, the estimated direction information generation unit 25 converts the probability density function into a function of a sound source search target direction θ using the relative delay time, and calculates the estimated direction information. The estimated direction information generation unit 25 outputs the calculated estimated direction information to the outside. The estimated direction information output from the estimated direction information generation unit 25 to the outside is used for estimating the wave source direction. The estimated direction information generation unit 25 may output the calculated estimated direction information to the outside every time the update of the time length of the averaging frame n is completed. That is, the estimated direction information generation unit 25 may output the probability density function of the averaging frame n at the timing when starting the calculation of the probability density function of the averaging frame n+1.

The sharpness calculation unit 26 is connected to the estimated direction information generation unit 25 and the time length calculation unit 27. A probability density function is input from the estimated direction information generation unit 25 to the sharpness calculation unit 26. The sharpness calculation unit 26 calculates the sharpness s of the peak of the probability density function input from the estimated direction information generation unit 25. The sharpness calculation unit 26 outputs the calculated sharpness s to the time length calculation unit 27.

For example, the sharpness calculation unit 26 calculates the kurtosis of the peak of the probability density function as the sharpness s. The kurtosis is generally used as an index representing sharpness of a probability density function.

The time length calculation unit 27 is connected to the signal extraction unit 23 and the sharpness calculation unit 26. The sharpness s is input from the sharpness calculation unit 26 to the time length calculation unit 27. The time length calculation unit 27 calculates the time length Tⁱ using the sharpness s input from the sharpness calculation unit 26. The time length calculation unit 27 outputs the calculated time length Tⁱ and the sharpness s to the signal extraction unit 23.

When the sharpness s falls below the threshold value sₘᵢₙ or when the sharpness s exceeds the threshold value sₘₐₓ, the time length calculation unit 27 updates the time length Tⁱ. When the sharpness s falls below the threshold value sₘᵢₙ, the time length calculation unit 27 updates the time length Tⁱ so that it is longer than the previously obtained time length. On the other hand, when the sharpness s exceeds the threshold value sₘₐₓ, the time length calculation unit 27 updates the time length Tⁱ so that it is shorter than the previously obtained time length Tⁱ⁻¹.

When the sharpness s falls below the threshold value sₘᵢₙ or when the sharpness s exceeds the threshold value sₘₐₓ, the time length calculation unit 27 updates the time length Tⁱ using, for example, the following Expression 2-5.

Tⁱ=Tⁱ⁻¹×a₁+b₁(sₙ≤sₘᵢₙ)

Tⁱ=Tⁱ⁻¹/a₂-b₂(sₙ≥sₘₐₓ) (2-5)

where the threshold value sₘᵢₙ and the threshold value sₘₐₓ are set to satisfy sₘᵢₙ<sₘₐₓ. i represents the number of update times, and a value equal to or more than 1 is set in advance as an initial value T⁰. Further, a₁ and a₂ are constants equal to or more than 1, and b₁ and b₂ are constants equal to or more than 0. In Expression 2-5, a₁, a₂, b₁, and b₂ are set such that the time length Tⁱ is an integer.

In Expression 2-5 described above, Tⁱ is set to be an integer equal to or more than 1. Therefore, for example, when Tⁱ calculated using Expression 2-5 is less than one, Tⁱ is set to one. The minimum value and the maximum value of the time length may be set in advance, and when the time length calculated by Expression 2-5 is less than a minimum value, the minimum value may be set to Tⁱ, and when the time length exceeds a maximum value, the maximum value may be set to Tᵢ.

For example, the threshold value sₘᵢₙ and the threshold value sₘₐₓ of the sharpness may be set by calculating a cross-correlation function when a signal-to-noise ratio (SN ratio) or a time length is changed and sharpness of the cross-correlation function by simulation in advance. For example, in the process of increasing the SN ratio and the time length, the value of the sharpness when the peak of the cross-correlation function starts to appear or the value when the sharpness starts to increase can be set as the threshold value sₘᵢₙ. For example, the value of the sharpness of the peak of the cross-correlation function detected in the process of increasing the SN ratio and the time length can be set as the threshold value sₘₐₓ.

In a case where the sharpness falls within a range of a preset threshold value, the time length calculation unit 27 sets the same value as the time length obtained last time as in the following Expression 2-6, and does not update the time length Tⁱ.

Tⁱ=Tⁱ⁻¹(sₘᵢₙ<s<sₘₐₓ) (2-6)

A preset fixed value may be given when the sharpness s falls within a preset threshold value range. The fixed value in this case may be set to the same value as the initial value, or may be set to a different value.

An example of the configuration of the wave source direction estimation device 20 of the present example embodiment is described above. The configuration of the wave source direction estimation device 20 in FIG. 3 is an example, and the configuration of the wave source direction estimation device 20 of the present example embodiment is not limited to the example.

### [Estimated Direction Information Generation Unit]

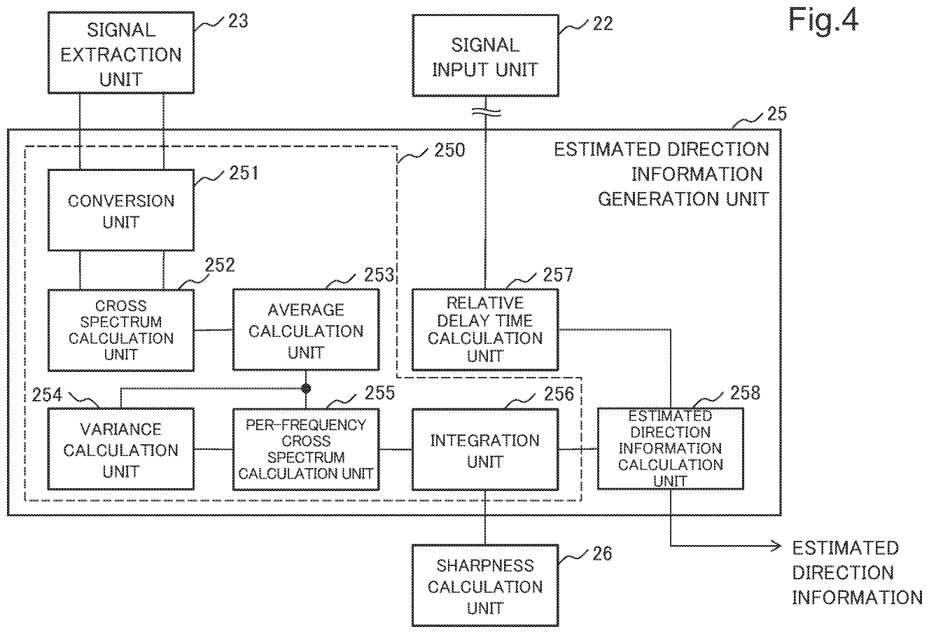

Next, a configuration of the estimated direction information generation unit 25 included in the wave source direction estimation device 20 will be described with reference to the drawings. FIG. 4 is a block diagram illustrating an example of a configuration of the estimated direction information generation unit 25. The estimated direction information generation unit 25 includes a conversion unit 251, a cross spectrum calculation unit 252, an average calculation unit 253, a variance calculation unit 254, a per-frequency cross spectrum calculation unit 255, an integration unit 256, a relative delay time calculation unit 257, and an estimated direction information calculation unit 258. The conversion unit 251, the cross spectrum calculation unit 252, the average calculation unit 253, the variance calculation unit 254, the per-frequency cross spectrum calculation unit 255, and the integration unit 256 constitute a function generation unit 250.

The conversion unit 251 is connected to the signal extraction unit 23. The conversion unit 251 is connected to the cross spectrum calculation unit 252. Two signals extracted from the first input signal x₁(t) and the second input signal x₂(t) are input to the conversion unit 251 from the signal extraction unit 23. The conversion unit 251 converts the two signals input from the signal extraction unit 23 into frequency domain signals. The conversion unit 251 outputs the two signals converted into the frequency domain signal to the cross spectrum calculation unit 252.

The conversion unit 251 performs conversion for decomposing the input signals into a plurality of frequency components. The conversion unit 251 converts two signals extracted from the first input signal x₁(t) and the second input signal x₂(t) into frequency domain signals, for example, using Fourier transform. Specifically, the conversion unit 251 extracts a signal segment from the two signals input from the signal extraction unit 23 while shifting waveforms each having an appropriate length at a constant cycle. The signal segment extracted by the conversion unit 251 is referred to as a converted frame, and the length of the extracted waveform is referred to as a converted frame length. The converted frame length is set to be shorter than the time length of the signal input from the signal extraction unit 23. Then, the conversion unit 251 converts the extracted signal into a frequency domain signal using Fourier transform.

Hereinafter, the averaging frame number is denoted as n, the frequency bin number is denoted as k, and the converted frame number is denoted as 1. Among the two signals extracted by the signal extraction unit 23, a signal extracted from the first input signal x₁(t) is denoted as x₁(t, n), and a signal extracted from the second input signal x₂(t) is denoted as x₂(t, n). There is also a case where any of x₁(t, n) and x₂(t, n) is expressed as xₘ(t, n) (m=1 or 2). A signal after conversion of xₘ(t, n) is expressed as xₘ(k, n, 1).

The cross spectrum calculation unit 252 is connected to the conversion unit 251 and the average calculation unit 253. Two converted signals Xₘ(k, n, 1) are input from the conversion unit 251 to the cross spectrum calculation unit 252. The cross spectrum calculation unit 252 calculates the cross spectrum S₁₂(k, n, 1) using the two converted signals Xₘ(k, n, 1) input from the conversion unit 251. The cross spectrum calculation unit 252 outputs the calculated cross spectrum S₁₂(k, n, 1) to the average calculation unit 253.

The average calculation unit 253 is connected to the cross spectrum calculation unit 252, the variance calculation unit 254, and the per-frequency cross spectrum calculation unit 255. The average calculation unit 253 receives the cross spectra S₁₂(k, n, 1) from the cross spectrum calculation unit 252. The average calculation unit 253 calculates an average value of the cross spectra S₁₂(k, n, 1) input from the cross spectrum calculation unit 252 regarding all the converted frames for each averaging frame. The average value calculated by the average calculation unit 253 is referred to as an average cross spectrum SS₁₂(k, n). The average calculation unit 253 outputs the calculated average cross spectrum SS₁₂(k, n) to the variance calculation unit 254 and the per-frequency cross spectrum calculation unit 255.

The variance calculation unit 254 is connected to the average calculation unit 253 and the per-frequency cross spectrum calculation unit 255. The average cross spectrum SS₁₂(k, n) is input from the average calculation unit 253 to the variance calculation unit 254. The variance calculation unit 254 calculates a variance V₁₂(k, n) using the average cross spectrum SS₁₂(k, n) input from the average calculation unit 253. The variance calculation unit 254 outputs the calculated variance V₁₂(k, n) to the per-frequency cross spectrum calculation unit 255.

In a case where the circumferential standard deviation is used in the calculation of the variance of the phase of the cross spectrum, the variance calculation unit 254 calculates the variance V₁₂(k, n) using, for example, the following Expression 2-7.

V₁₂(k,n)=\sqrt{−2 ln|SS₁₂(k,n)|} (2-7)

The above Expression 2-7 is an example, and does not limit the method of calculating the variance V₁₂(k, n) by the variance calculation unit 254.

The per-frequency cross spectrum calculation unit 255 is connected to the average calculation unit 253, the variance calculation unit 254, and the integration unit 256. The per-frequency cross spectrum calculation unit 255 receives the average cross spectrum SS₁₂(k, n) from the average calculation unit 253 and the variance V₁₂(k, n) from the variance calculation unit 254. The per-frequency cross spectrum calculation unit 255 calculates the per-frequency cross spectrum UMₖ(w, n) using the average cross spectrum SS₁₂(k, n) input from the average calculation unit 253 and the variance V₁₂(k, n) supplied from the variance calculation unit 254. The per-frequency cross spectrum calculation unit 255 outputs the calculated per-frequency cross spectrum UMₖ(w, n) to the integration unit 256.

First, the per-frequency cross spectrum calculation unit 255 calculates a cross spectrum relevant of the average cross spectrum SS₁₂(k, n) to each frequency k using the average cross spectrum SS₁₂(k, n) input from the average calculation unit 253. For example, the per-frequency cross spectrum calculation unit 255 calculates the cross spectrum Uₖ(k, n) of the average cross spectrum SS₁₂(w, n) relevant to each frequency k using the following Expression 2-8.

$${U}_{k} ( w , n ) = \{ \begin{matrix}{{SS}_{12} ( k , n )}^{p} , & if w = p \cdot k \\ 0 , & if w \neq p \cdot k\end{matrix} \qquad ( 2 - 8 )$$

In Expression 2-8, p is an integer equal to or more than 1.

Next, the per-frequency cross spectrum calculation unit 255 obtains a kernel function spectrum G(w) using the variance V₁₂(k, n) input from the variance calculation unit 254. For example, the per-frequency cross spectrum calculation unit 255 performs a Fourier transform on the kernel function g(τ) and obtains the kernel function spectrum G(w) by taking the absolute value of the Fourier transformed the kernel function g(τ) For example, the per-frequency cross spectrum calculation unit 255 performs a Fourier transform on the kernel function g(τ) and obtains the kernel function spectrum G(w) by taking a square value thereof. For example, the per-frequency cross spectrum calculation unit 255 performs a Fourier transform on the kernel function g(τ) and obtains the kernel function spectrum G(w) by taking the square of the absolute value thereof.

For example, the per-frequency cross spectrum calculation unit 255 uses a Gaussian function or a logistic function as the kernel function g(τ). The per-frequency cross spectrum calculation unit 255 uses, for example, a Gaussian function of the following Expression 2-9 as the kernel function g(τ).

$$g ( τ ) = {g}_{1} exp ( - \frac{{( τ - {g}_{2} )}^{2}}{2 {g}_{3}^{2}} ) \qquad ( 2 - 9 )$$

In Expression 2-9 above, g₁, g₂, and g₃ are positive real numbers. g₁ is a parameter for controlling the magnitude of the Gaussian function, g₂ is a parameter for controlling the position of the peak of the Gaussian function, and g₃ is a parameter for controlling the spread of the Gaussian function. Among the parameters of the Gaussian function, g₃ that affects the spread of the kernel function g(τ) is calculated using the variance V₁₂(k, n) input from the variance calculation unit 254. g₃ may be the variance V₁₂(k, n) itself. g₃ may be a positive constant in each of a case where the variance V₁₂(k, n) exceeds a preset threshold value and a case where the variance V₁₂(k, n) does not exceed the preset threshold value, but g₃ is set to be larger as the variance V₁₂(k, n) is larger.

Then, the per-frequency cross spectrum calculation unit 255 calculates the per-frequency cross spectrum UMₖ(w, n) by multiplying the cross spectrum Uₖ(w, n) by the kernel function spectrum G(w) as in the following Expression 2-10.

UMₖ(w,n)=G(w)Uₖ(w,n) (2-10)

The above Expression 2-10 is an example, and does not limit the method of calculating the per-frequency cross spectrum UMₖ(w, n) by the per-frequency cross spectrum calculation unit 255.

The integration unit 256 is connected to the per-frequency cross spectrum calculation unit 255 and the estimated direction information calculation unit 258. The integration unit 256 is connected to the sharpness calculation unit 26. The per-frequency cross spectra UMₖ(w, n) are input from the per-frequency cross spectrum calculation unit 255 to the integration unit 256. The integration unit 256 integrates the per-frequency cross spectra UMₖ(w, n) input from the per-frequency cross spectrum calculation unit 255 to calculate an integrated cross spectrum U(k, n). Then, the integration unit 256 performs an inverse Fourier transform on the integrated cross spectrum U(k, n) to calculate a probability density function u(τ, n). The integration unit 256 outputs the calculated probability density function u(τ, n) to the estimated direction information calculation unit 258 and the sharpness calculation unit 26.

The integration unit 256 calculates one integrated cross spectrum U(w, n) by mixing or superimposing a plurality of per-frequency cross spectra UMₖ(k, n). For example, the integration unit 256 calculates the integrated cross spectrum U(k, n) by summing or multiplying a plurality of per-frequency cross spectra UMₖ(w, n). The integration unit 256 calculates an integrated cross spectrum U(k, n) by summing a plurality of per-frequency cross spectra UMₖ(w, n) using the following Expression 2-11, for example.

$$U ( k , n ) = {\prod }_{w = 0}^{W - 1} {UM}_{k} ( w , n ) \qquad ( 2 - 11 )$$

The above Expression 2-11 is an example, and does not limit the method of calculating the integrated cross spectrum U(k, n) by the integration unit 256.

The relative delay time calculation unit 257 is connected to the estimated direction information calculation unit 258. The relative delay time calculation unit 257 is connected to the signal input unit 22. The relative delay time calculation unit 257 may be directly connected to the signal input unit 22 or may be connected to the signal input unit 22 via the signal extraction unit 23. A sound source search target direction is set in advance in the relative delay time calculation unit 257. For example, the sound source search target direction is a sound arrival direction and is set at predetermined angle intervals. When the microphone position information of the microphone 211 and the microphone 212 is known, the microphone position information may be stored in a storage unit accessible by the estimated direction information generation unit 25, and the relative delay time calculation unit 257 and the signal input unit 22 may not be connected to each other.

The relative delay time calculation unit 257 receives microphone position information from the signal input unit 22. The relative delay time calculation unit 257 calculates a relative delay time between two microphones by using a preset sound source search target direction and microphone position information. The relative delay time is an arrival time difference, of a sound wave, uniquely determined based on an interval between two microphones and a sound source search target direction. That is, the relative delay time calculation unit 257 calculates the relative delay time for the set sound source search target direction. The relative delay time calculation unit 257 outputs the calculated set of the sound source search target direction and the relative delay time to the estimated direction information calculation unit 258.

The relative delay time calculation unit 257 calculates the relative delay time τ(θ) by using the following Expression 2-12, for example.

$$τ ( θ ) = \frac{d cos θ}{c} \qquad ( 2 - 12 )$$

In the above Expression 2-12, c is the sound velocity, d is the interval between the microphone 211 and the microphone 212, and θ is the sound source search target direction.

The relative delay time τ(θ) is calculated for all the sound source search target directions θ. For example, in a case where the search range of the sound source search target direction θ is set in increments of 10 degrees in the range of 0 degrees to 90 degrees, a total of 10 types of relative delay times τ(θ) are calculated with respect to the sound source search target directions θ of 0 degrees, 10 degrees, 20 degrees, . . . , and 90 degrees.

The estimated direction information calculation unit 258 is connected to the integration unit 256 and the relative delay time calculation unit 257. The estimated direction information calculation unit 258 receives the probability density function u(τ, n) from the integration unit 256, and receives the set of the sound source search target direction θ and the relative delay time τ(θ) from the relative delay time calculation unit 257. The estimated direction information calculation unit 258 calculates the estimated direction information H(θ, n) by converting the probability density function u(τ, n) into a function of the sound source search target direction θ using the relative delay time τ(θ).

The estimated direction information calculation unit 258 calculates the estimated direction information H(θ, n) using, for example, the following Expression 2-13.

H(θ,n)=u(τ(θ),n) (2-13)

Since the estimated direction information is determined for each sound source search target direction θ by using the above Expression 2-13, it can be determined that a target sound source 200 is highly likely to exist in a direction in which the estimated direction information is high.

An example of the configuration of the wave source direction estimation device 20 of the present example embodiment is described above. The configuration of the wave source direction estimation device 20 in FIG. 3 is an example, and the configuration of the wave source direction estimation device 20 of the present example embodiment is not limited to the example. The configuration of the estimated direction information generation unit 25 in FIG. 4 is an example, and the configuration of the estimated direction information generation unit 25 of the present example embodiment is not limited to example.

(Operation)

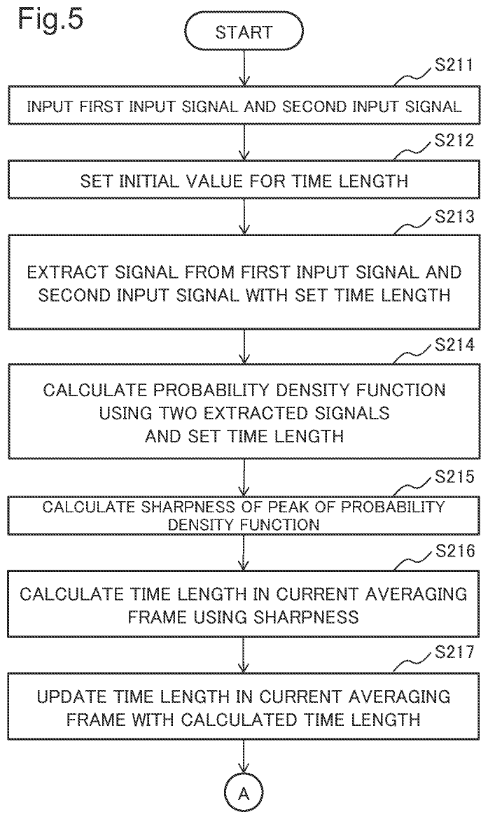

Next, an example of the operation of the wave source direction estimation device 20 of the present example embodiment will be described with reference to the drawings. FIGS. 5 to 7 are flowcharts for explaining the operation of the wave source direction estimation device 20.

In FIG. 5, first, a first input signal and a second input signal are input to the signal input unit 22 of the wave source direction estimation device 20 (step S211).

Next, the signal extraction unit 23 of the wave source direction estimation device 20 sets an initial value for the time length (step S212).

Next, the signal extraction unit 23 of the wave source direction estimation device 10 extracts a signal from each of the first input signal and the second input signal at a set time length (step S213).

Next, the estimated direction information generation unit 25 of the wave source direction estimation device 20 calculates a probability density function using two signals extracted from the first input signal and the second input signal and the set time length (step S214).

Next, the sharpness calculation unit 26 of the wave source direction estimation device 20 calculates the sharpness of the calculated probability density function (step S215).

Next, the time length calculation unit 27 of the wave source direction estimation device 20 calculates the time length of the current averaging frame using the calculated sharpness (step S216).

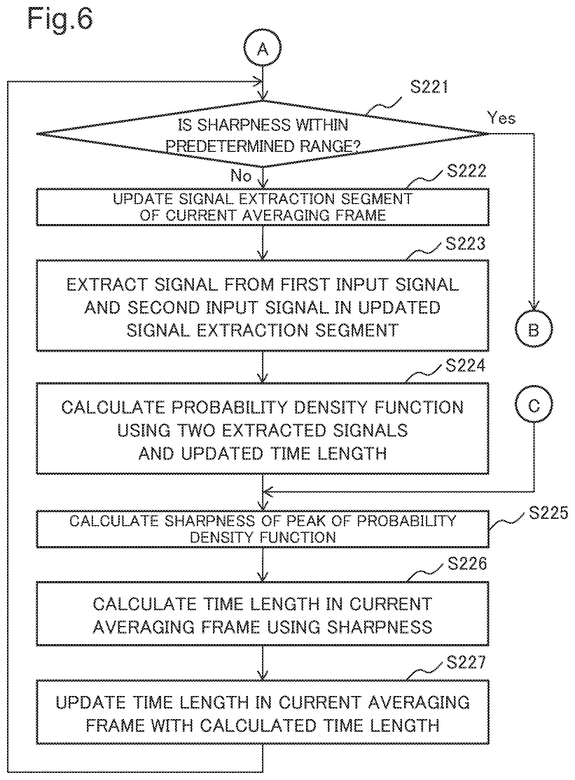

Next, the time length calculation unit 27 of the wave source direction estimation device 20 updates the time length of the current averaging frame at the calculated time length (step S217). After step S217, the process proceeds to step S221 (A) in FIG. 6.

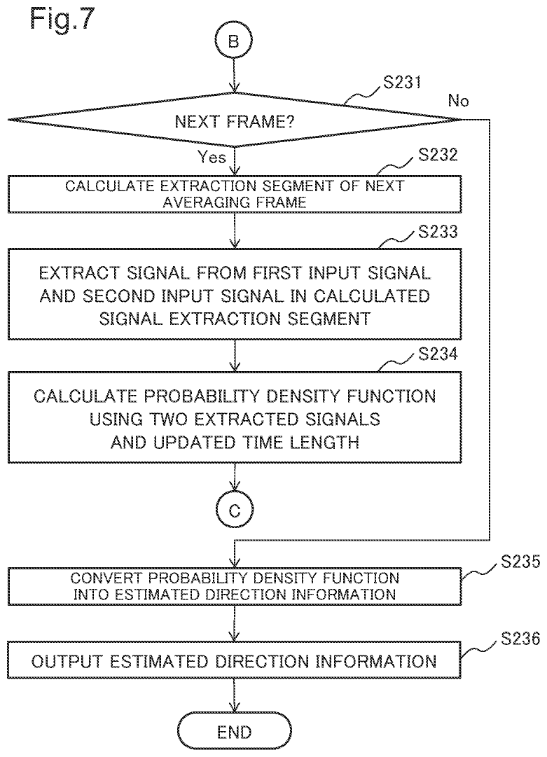

In FIG. 6, when the sharpness calculated for the current averaging frame falls within the predetermined range (Yes in step S221), the process proceeds to step S231 (B) in FIG. 7.

On the other hand, when the sharpness calculated for the current averaging frame does not fall within the predetermined range (No in step S221), the signal extraction unit 23 of the wave source direction estimation device 20 updates the signal extraction segment of the current averaging frame (step S222).

Next, the signal extraction unit 23 of the wave source direction estimation device 10 extracts a signal from each of the first input signal and the second input signal in the updated signal extraction segment (step S223).

Next, the estimated direction information generation unit 25 of the wave source direction estimation device 20 calculates a probability density function using two signals extracted from the first input signal and the second input signal and the updated time length (step S224).

Next, the sharpness calculation unit 26 of the wave source direction estimation device 20 calculates the sharpness of the calculated probability density function (step S225).

Next, the time length calculation unit 27 of the wave source direction estimation device 20 calculates the time length of the current averaging frame using the calculated sharpness (step S226).

Next, the time length calculation unit 27 of the wave source direction estimation device 20 updates the time length of the current averaging frame at the calculated time length (step S227). After step S227, the process returns to step S221.

In FIG. 7, first, when there is the next frame (Yes in step S231), the signal extraction unit 23 of the wave source direction estimation device 20 calculates a signal extraction segment of the next averaging frame (step S232). On the other hand, when there is no next frame (No in step S231), the process proceeds to step S235.

Next, the signal extraction unit 23 of the wave source direction estimation device 10 extracts a signal from each of the first input signal and the second input signal at the calculated signal extraction segment (step S233).

Next, the estimated direction information generation unit 25 of the wave source direction estimation device 20 calculates a probability density function using two signals extracted from the first input signal and the second input signal and the updated time length (step S234). After step S234, the process returns to step S225 (C) in FIG. 6.

In step S231, when there is no next frame (No in step S231), the estimated direction information generation unit 25 of the wave source direction estimation device 20 converts the probability density function calculated for all the averaging frames into the estimated direction information (step S235).

Then, the estimated direction information generation unit 25 of the wave source direction estimation device 20 outputs the calculated estimated direction information (step S236).

An example of the operation of the wave source direction estimation device 20 of the present example embodiment is described above. The operation of the wave source direction estimation device 20 in FIGS. 5 to 7 is an example, and the operation of the wave source direction estimation device 20 of the present example embodiment is not limited to the procedure as it is.

### [Estimated Direction Information Generation Unit]

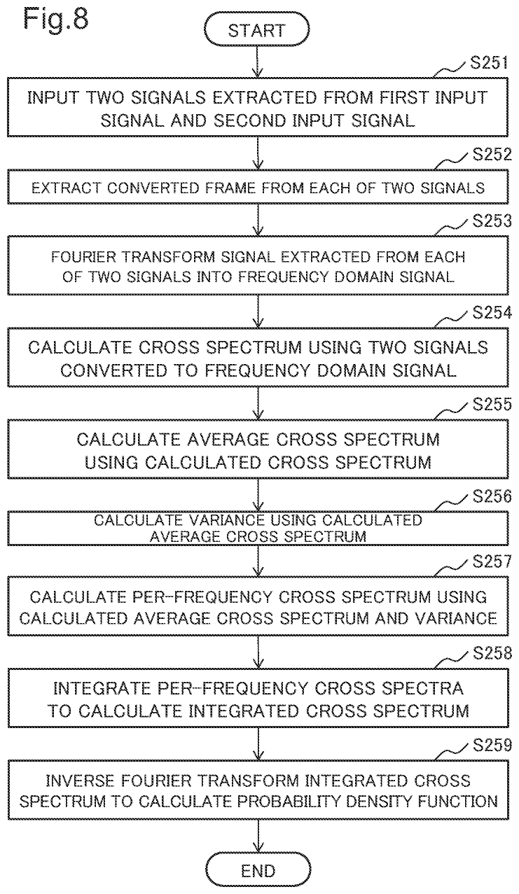

Next, a process in which the estimated direction information generation unit 25 of the wave source direction estimation device 20 according to the present example embodiment calculates a probability density function will be described with reference to the drawings. FIG. 8 is a flowchart for explaining a process in which the estimated direction information generation unit 25 calculates a probability density function.

In FIG. 8, first, two signals extracted from the first input signal and the second input signal are input from the signal extraction unit 23 to the conversion unit 251 of the estimated direction information generation unit 25 (step S251).

Next, the conversion unit 251 of the estimated direction information generation unit 25 extracts a converted frame from each of the two input signals (step S252).

Next, the conversion unit 251 of the estimated direction information generation unit 25 performs a Fourier transform on the converted frame extracted from each of the two signals to convert the converted frame into a frequency domain signal (step S253).

Next, the cross spectrum calculation unit 252 of the estimated direction information generation unit 25 calculates a cross spectrum using the two signals converted into the frequency domain signal (step S254).

Next, the average calculation unit 253 of the estimated direction information generation unit 25 calculates an average value (average cross spectrum) about all the converted frames for the averaging frame of the cross spectrum (step S255).

Next, the variance calculation unit 254 of the estimated direction information generation unit 25 calculates a variance using the average cross spectrum (step S256).

Next, the per-frequency cross spectrum calculation unit 255 of the estimated direction information generation unit 25 calculates a per-frequency cross spectrum using the average cross spectrum and the variance (step S257).

Next, the integration unit 256 of the estimated direction information generation unit 25 integrates the plurality of per-frequency cross spectra to calculate an integrated cross spectrum (step S258).

Then, the integration unit 256 of the estimated direction information generation unit 25 performs an inverse Fourier transform on the integrated cross spectrum to calculate a probability density function (step S259). The integration unit 256 of the estimated direction information generation unit 25 outputs the probability density function calculated in step S259 to the sharpness calculation unit 26.

An example of the operation of the estimated direction information generation unit 25 of the present example embodiment is described above. The operation of the estimated direction information generation unit 25 in FIG. 6 is an example, and the operation of the estimated direction information generation unit 25 of the present example embodiment is not limited to the procedure as it is.

As described above, the wave source direction estimation device of the present example embodiment includes the signal input unit, the signal extraction unit, the estimated direction information generation unit, the sharpness calculation unit, and the time length calculation unit. At least two input signals based on a wave detected at different positions are input to the signal input unit. The signal extraction unit sequentially extracts, one at a time, signals of signal segments according to a set time length from at least two input signals. The estimated direction information generation unit calculates per-frequency cross spectra from at least two signals extracted by the signal extraction unit, and integrates the calculated per-frequency cross spectra to calculate an integrated cross spectrum. The estimated direction information generation unit calculates a probability density function by inversely transforming the calculated integrated cross spectrum. The sharpness calculation unit calculates the sharpness of a peak of the probability density function. The time length calculation unit calculates a time length based on the sharpness and makes the calculated time length the set time length.

In an embodiment of the present example embodiment, the sharpness calculation unit of the wave source direction estimation device calculates the peak-signal to noise ratio of the probability density function as the sharpness.

In an embodiment of the present example embodiment, in a case where the sharpness is out of a range between a preset minimum threshold value and maximum threshold value, the signal extraction unit of the wave source direction estimation device updates the extraction segment of the signal segment being processed with the end of the previously processed signal segment as a reference based on the set time length. When the sharpness falls within the range between the minimum threshold value and the maximum threshold value, the signal extraction unit does not update the extraction segment of the signal segment being processed, and sets the extraction segment of the next signal segment with the end of the signal segment being processed as a reference based on the set time length.

In an embodiment of the present example embodiment, the wave source direction estimation device further includes a relative delay time calculation unit and an estimated direction information calculation unit. The relative delay time calculation unit calculates, for the set wave source search target direction, a relative delay time indicating an arrival time difference, of a wave, uniquely determined based on position information on at least two detection positions and the wave source search target direction. The estimated direction information calculation unit calculates the estimated direction information by converting the probability density function into a function of the sound source search target direction using the relative delay time.

In the present example embodiment, the time length is updated until the sharpness of the cross-correlation function in the current averaging frame falls within a preset threshold value range. Therefore, according to the present example embodiment, similarly to the first example embodiment, control is performed so that the sharpness is sufficiently large and the time length is as small as possible, and the direction of the sound source can be estimated with high accuracy. According to the present example embodiment, by updating the time length of the current averaging frame based on the sharpness of the cross-correlation function in the current averaging frame, the time length is closer to the optimum value than in the first example embodiment. Therefore, the direction of the sound source according to the present example embodiment can be estimated with higher accuracy as compared with that according to the first example embodiment.

In the present example embodiment, an example is described in which the method of updating the time length based on the sharpness of the probability density function in the current averaging frame is applied to the sound source direction estimation method of calculating the arrival time difference based on the probability density function. The method of the present example embodiment can also be applied to a sound source direction estimation method using an arrival time difference based on a general cross-correlation function represented by the GCC-PHAT method described in the first example embodiment. When the method of the present example embodiment is applied to the first example embodiment, the time length may be updated based on the sharpness of the cross-correlation function in the current averaging frame. As described in the first example embodiment, a method of setting the time length based on the sharpness of the probability density function in the previous frame may be applied to the sound source direction estimation method of calculating the arrival time difference based on the probability density function of the present example embodiment.

In the first example embodiment and the second example embodiment, the method of adaptively setting the time length in the method of estimating the direction of the sound source from the arrival time difference between the two input signals is described. However, the methods of the first example embodiment and the second example embodiment are not limited thereto, and may be applied to other sound source direction estimation methods such as a beamforming method and a subspace method.

### Third Example Embodiment

Next, a wave source direction estimation device according to the third example embodiment will be described with reference to the drawings. The wave source direction estimation device of the present example embodiment has a configuration in which a signal input unit is removed from the wave source direction estimation devices of the first and second example embodiments.

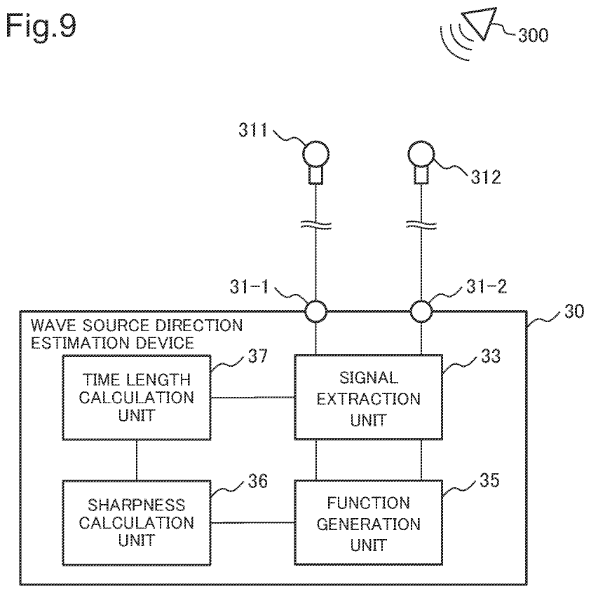

FIG. 9 is a block diagram illustrating an example of a configuration of a wave source direction estimation device 30 of the present example embodiment. The wave source direction estimation device 30 includes a signal extraction unit 33, a function generation unit 35, a sharpness calculation unit 36, and a time length calculation unit 37. The wave source direction estimation device 30 includes a first input terminal 31-1 and a second input terminal 31-2. Although FIG. 9 illustrates a configuration in which the signal input unit is omitted, the signal input unit may be provided as in the first and second example embodiments.

The first input terminal 31-1 and the second input terminal 31-2 are connected to the signal extraction unit 33. The first input terminal 31-1 is connected to a microphone 311, and the second input terminal 31-2 is connected to a microphone 312. In the present example embodiment, the microphone 311 and the microphone 312 are not included in the configuration of the wave source direction estimation device 30.

The microphone 311 and the microphone 312 are disposed at different positions. The microphone 311 and the microphone 312 collect sound waves in which sound from a target sound source 300 and various noises generated in the surroundings are mixed. The microphone 311 and the microphone 312 convert collected sound waves into digital signals (also referred to as sound signals). The microphone 311 and the microphone 312 outputs the converted sound signals to the first input terminal 31-1 and the second input terminal 31-2, respectively.

A sound signal converted from a sound wave collected by each of the microphone 311 and the microphone 312 is input to each of the first input terminal 31-1 and the second input terminal 31-2. The sound signal input to each of the first input terminal 31-1 and the second input terminal 31-2 constitutes a sample value sequence. Hereinafter, a sound signal input to each of the first input terminal 31-1 and the second input terminal 31-2 is referred to as an input signal.

The signal extraction unit 33 is connected to the first input terminal 31-1 and the second input terminal 31-2. The signal extraction unit 33 is connected to the function generation unit 35 and the time length calculation unit 37. An input signal is input from each of the first input terminal 31-1 and the second input terminal 31-2 to the signal extraction unit 33. The time length is input from the time length calculation unit 37 to the signal extraction unit 33. The signal extraction unit 33 sequentially extracts, one at a time, signals of signal segments according to the time length input from the time length calculation unit 37 from the input first input signal and second input signal. The signal extraction unit 33 outputs two signals extracted from the first input signal and the second input signal to the function generation unit 35.

The function generation unit 35 is connected to the signal extraction unit 33 and the sharpness calculation unit 36. Two signals extracted from the first input signal and the second input signal are input to the function generation unit 35 from the signal extraction unit 33. The function generation unit 35 generates a function associating the two signals input from the signal extraction unit 33. For example, the function generation unit 35 calculates a cross-correlation function by the method of the first example embodiment. For example, the function generation unit 35 calculates a probability density function by the method of the second example embodiment. The function generation unit 35 outputs the generated function to the sharpness calculation unit 36.

The sharpness calculation unit 36 is connected to the function generation unit 35 and the time length calculation unit 37. The function generated by the function generation unit 35 is input to the sharpness calculation unit 36. The sharpness calculation unit 36 calculates the sharpness of the peak of the function input from the function generation unit 35. For example, when calculating the cross-correlation function by the method of the first example embodiment, the function generation unit 35 calculates the kurtosis of a peak of the cross-correlation function as the sharpness. For example, when calculating the probability density function by the method of the second example embodiment, the function generation unit 35 calculates the peak-signal to noise ratio of the probability density function as the sharpness. The sharpness calculation unit 36 outputs the calculated sharpness to the time length calculation unit 37.

The time length calculation unit 37 is connected to the signal extraction unit 33 and the sharpness calculation unit 36. The sharpness is input from the sharpness calculation unit 36 to the time length calculation unit 37. The time length calculation unit 37 calculates a time length based on the sharpness input from the sharpness calculation unit 36. For example, the time length calculation unit 37 calculates the frame time length according to the magnitude of the sharpness by using Expression 1-4. The time length calculation unit 37 sets the calculated time length in the signal extraction unit 33.

An example of the configuration of the wave source direction estimation device 30 of the present example embodiment is described above. The configuration of the wave source direction estimation device 30 in FIG. 9 is an example, and the configuration of the wave source direction estimation device 30 of the present example embodiment is not limited to the example.

(Operation)

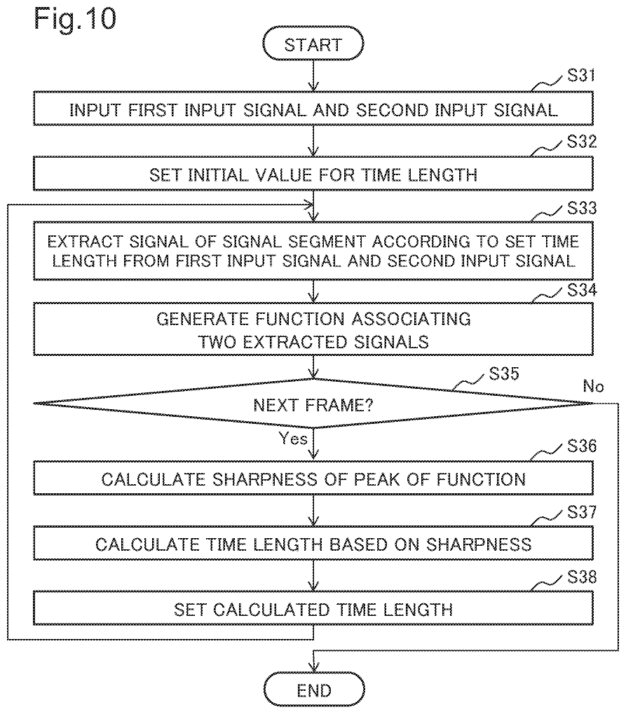

Next, an example of the operation of the wave source direction estimation device 30 of the present example embodiment will be described with reference to the drawings. FIG. 10 is a flowchart for explaining the operation of the wave source direction estimation device 30.

In FIG. 10, first, a first input signal and a second input signal are input to the signal extraction unit 33 of the wave source direction estimation device 30 (step S31).

Next, the signal extraction unit 33 of the wave source direction estimation device 30 sets an initial value for the time length (step S32).

Next, the signal extraction unit 33 of the wave source direction estimation device 30 extracts a signal from each of the first input signal and the second input signal with a signal segment according to the set time length (step S33).

Next, the function generation unit 35 of the wave source direction estimation device 30 generates a function associating the two signals extracted from the first input signal and the second input signal (step S34).

Here, when there is the next frame (Yes in step S35), the sharpness calculation unit 36 of the wave source direction estimation device 30 calculates the sharpness of the peak of the function calculated in step S34 (step S36). On the other hand, when there is no next frame (No in step S35), the process according to the flowchart of FIG. 10 ends.

Next, the time length calculation unit 37 of the wave source direction estimation device 30 calculates the time length using the sharpness calculated in step S36 (step S37).

Next, the time length calculation unit 37 of the wave source direction estimation device 30 sets the calculated time length (step S38). After step S38, the process returns to step S33.

An example of the operation of the wave source direction estimation device 30 of the present example embodiment is described above. In the example of the operation arrangement of the wave source direction estimation device 30 in FIG. 2, the operation of the wave source direction estimation device 30 of the present example embodiment is not limited to the procedure as it is.

As described above, the wave source direction estimation device of the present example embodiment includes the signal extraction unit, the function generation unit, the sharpness calculation unit, and the time length calculation unit. At least two input signals based on the wave detected at different positions are input to the signal extraction unit. The signal extraction unit sequentially extracts, one at a time, signals of signal segments according to a set time length from at least two input signals. The function generation unit generates a function associating at least two signals extracted by the signal extraction unit. The sharpness calculation unit calculates the sharpness of a cross-correlation function peak. The time length calculation unit calculates a time length based on the sharpness and makes the calculated time length the set time length.

According to the present example embodiment, since the time length is reset based on the sharpness, the direction of the sound source can be estimated with high accuracy. In other words, according to the present example embodiment, it is possible to achieve both time resolution and estimation accuracy and to estimate the direction of the sound source with high accuracy.

(Hardware)

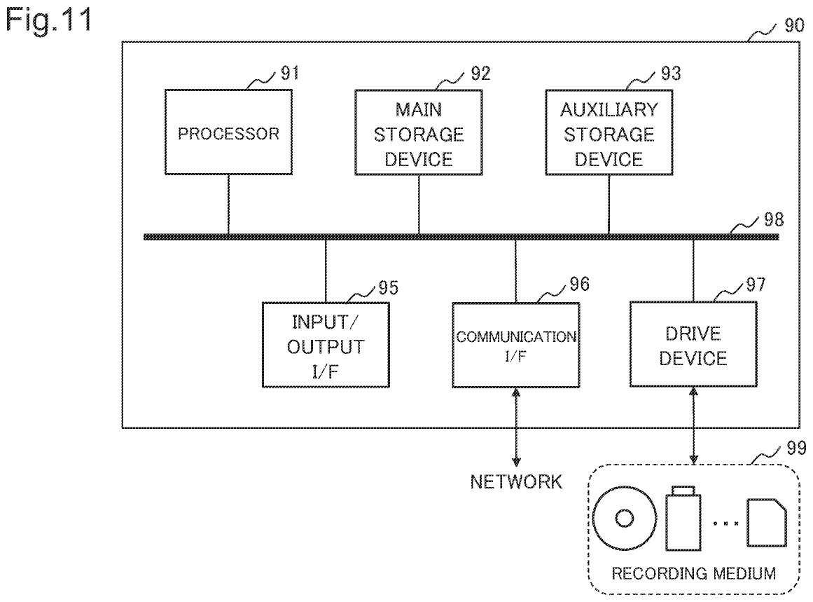

Here, a hardware configuration for executing the process of the wave source direction estimation device according to each example embodiment will be described using an information processing apparatus 90 in FIG. 11 as an example. The information processing apparatus 90 in FIG. 11 is a configuration example for performing the process of the wave source direction estimation device of each example embodiment, and does not limit the scope of the present invention.

As illustrated in FIG. 11, the information processing apparatus 90 includes a processor 91, a main storage device 92, an auxiliary storage device 93, an input/output interface 95, a communication interface 96, and a drive device 97. In FIG. 11, the interface is abbreviated as an interface (I/F). The processor 91, the main storage device 92, the auxiliary storage device 93, the input/output interface 95, the communication interface 96, and the drive device 97 are data-communicably connected to each other via a bus 98. The processor 91, the main storage device 92, the auxiliary storage device 93, and the input/output interface 95 are connected to a network such as the Internet or an intranet via the communication interface 96. FIG. 11 illustrates a recording medium 99 capable of recording data.

The processor 91 develops the program stored in the auxiliary storage device 93 or the like in the main storage device 92 and executes the developed program. In the present example embodiment, a software program installed in the information processing apparatus 90 may be used. The processor 91 executes a process by the wave source direction estimation device according to the present example embodiment.

The main storage device 92 has an area in which a program is developed. The main storage device 92 may be a volatile memory such as a dynamic random access memory (DRAM). A non-volatile memory such as a magnetoresistive random access memory (MRAM) may be configured and added as the main storage device 92.

The auxiliary storage device 93 stores various pieces of data. The auxiliary storage device 93 includes a local disk such as a hard disk or a flash memory. Various pieces of data may be stored in the main storage device 92, and the auxiliary storage device 93 may be omitted.

The input/output interface 95 is an interface for connecting the information processing apparatus 90 with a peripheral device. The communication interface 96 is an interface for connecting to an external system or a device through a network such as the Internet or an intranet based on a standard or a specification. The input/output interface 95 and the communication interface 96 may be shared as an interface connected to an external device.

An input device such as a keyboard, a mouse, or a touch panel may be connected to the information processing apparatus 90 as necessary. These input devices are used to input information and settings. When the touch panel is used as the input device, the display screen of the display device may also serve as the interface of the input device. Data communication between the processor 91 and the input device may be mediated by the input/output interface 95.

The information processing apparatus 90 may be provided with a display device that displays information. In a case where a display device is provided, the information processing apparatus 90 preferably includes a display control device (not illustrated) that controls display of the display device. The display device may be connected to the information processing apparatus 90 via the input/output interface 95.

The drive device 97 is connected to the bus 98. The drive device 97 mediates reading of data and a program from the recording medium 99, writing of a processing result of the information processing apparatus 90 to the recording medium 99, and the like between the processor 91 and the recording medium 99 (program recording medium). When the recording medium 99 is not used, the drive device 97 may be omitted.

The recording medium 99 can be achieved by, for example, an optical recording medium such as a compact disc (CD) or a digital versatile disc (DVD). The recording medium 99 may be achieved by a semiconductor recording medium such as a Universal Serial Bus (USB) memory or a secure digital (SD) card, a magnetic recording medium such as a flexible disk, or another recording medium. In a case where the program executed by the processor is recorded in the recording medium 99, the recording medium 99 is a program recording medium.

The above is an example of a hardware configuration for enabling the wave source direction estimation device according to each example embodiment. The hardware configuration of FIG. 11 is an example of a hardware configuration for performing the arithmetic process of the wave source direction estimation device according to each example embodiment, and does not limit the scope of the present invention. A program for causing a computer to execute processing related to the wave source direction estimation device according to each example embodiment is also included in the scope of the present invention. A program recording medium in which the program according to each example embodiment is recorded is also included in the scope of the present invention.

The components of the wave source direction estimation device of each example embodiment can be combined in any manner. The components of the wave source direction estimation device of each example embodiment may be achieved by software or may be achieved by a circuit.

While the present invention has been described with reference to example embodiments thereof, the present invention is not limited to these example embodiments. Various modifications that can be understood by those skilled in the art can be made to the configuration and details of the present invention within the scope of the present invention.

### REFERENCE SIGNS LIST

10, 20, 30 wave source direction estimation device
11-1, 21-1, 31-1 first input terminal
11-2, 21-2, 31-2 second input terminal
12, 22 signal input unit
13, 23, 33 signal extraction unit
15 cross-correlation function calculation unit
16, 26, 36 sharpness calculation unit
17, 27, 37 time length calculation unit
25 estimated direction information generation unit
111, 112, 211, 212, 311, 312 microphone
250 function generation unit
251 conversion unit
252 cross spectrum calculation unit
253 average calculation unit
254 variance calculation unit
255 per-frequency cross spectrum calculation unit
256 integration unit
257 relative delay time calculation unit
258 estimated direction information calculation unit

What is claimed is:

1. A wave source direction estimation device comprising:
at least one memory storing instructions; and
at least one processor connected to the at least one memory and configured to execute the instructions to:
sequentially extract, one at a time, signals of signal segments according to a set time length from at least two input signals based on a wave detected at different detection positions;
generate a function associating the at least two signals that are extracted;
calculate sharpness of a peak of the function; and
calculate the time length based on the sharpness and set the calculated time length.

2. The wave source direction estimation device according to claim 1, wherein
the at least one processor is configured to execute the instructions to
do not update the time length when the sharpness falls within a range between a preset minimum threshold value and a preset maximum threshold value,
increase the time length when the sharpness is smaller than the minimum threshold value, and
decrease the time length when the sharpness is greater than the maximum threshold value.

3. The wave source direction estimation device according to claim 1, wherein
the at least one processor is configured to execute the instructions to
update, based on the set time length, an extraction segment of a signal segment being processed with an end of the previously processed signal segment as a reference when the sharpness is out of a range between a preset minimum threshold value and a preset maximum threshold value, and
do not update an extraction segment of the signal segment being processed when the sharpness falls within a range between the minimum threshold value and the maximum threshold value and set an extraction segment of a next signal segment with an end of the signal segment being processed as a reference based on the set time length.

4. The wave source direction estimation device according to claim 1, wherein
the at least one processor is configured to execute the instructions to
convert the at least two signals that are extracted into a frequency spectrum,
calculate a cross spectrum of the at least two signals after conversion into the frequency spectrum, and
calculate a cross-correlation function by normalizing the calculated cross spectrum with an absolute value of the cross spectrum and then performing an inverse conversion on the normalized cross spectrum, and
calculate the sharpness for a peak of the cross-correlation function that are generated.

5. The wave source direction estimation device according to claim 4, wherein
the at least one processor is configured to execute the instructions to
calculate a kurtosis of a peak of the cross-correlation function as the sharpness.

6. The wave source direction estimation device according to claim 1 wherein
the at least one processor is configured to execute the instructions to
calculate per-frequency cross spectra from the at least two signals that are extracted,
integrate the calculated per-frequency cross spectra to calculate an integrated cross spectrum, and
calculate a probability density function by inversely converting the calculated integrated cross spectrum, and
calculate the sharpness for a peak of the probability density function.

7. The wave source direction estimation device according to claim 6, wherein
the at least one processor is configured to execute the instructions to calculate a peak-signal to noise ratio of the probability density function as the sharpness.

8. The wave source direction estimation device according to claim 6, wherein the at least one processor is configured to execute the instructions to:
calculate, for a set wave source search target direction, a relative delay time indicating an arrival time difference, of the wave, uniquely determined based on position information on at least two of the detection positions and the wave source search target direction; and
calculate estimated direction information by converting the probability density function into a function of the wave source search target direction using the relative delay time.

9. A wave source direction estimation method, comprising:
inputting at least two input signals based on a wave detected at different detection positions;
sequentially extracting, one at a time, signals of signal segments according to a set time length from the at least two input signals;
calculating a cross-correlation function using the at least two signals extracted and the time length;
calculating a sharpness of a peak of the cross-correlation function;
calculating the time length according to the sharpness; and
setting the calculated time length to a signal segment to be extracted next.

10. A non-transitory program recording medium storing a program for causing a computer to execute processing of:
inputting at least two input signals based on a wave detected at different detection positions;
sequentially extracting, one at a time, signals of signal segments according to a set time length from the at least two input signals;
calculating a cross-correlation function using the at least two signals extracted and the time length;
calculating a sharpness of a peak of the cross-correlation function;
calculating the time length according to the sharpness; and
setting the calculated time length to a signal segment to be extracted next.
